(19) United States
(12) Patent Application Publication
(10) Pub. No.: US 2011/0113225 A1
(43) Pub. Date: May 12, 2011

(54) BASIC INPUT/OUTPUT SYSTEM CAPABLE OF SUPPORTING MULTI-PLATFORMS AND CONSTRUCTING METHOD THEREOF

(75) Inventors: Ying-Chih Lu, Taipei (TW); Wen-Ping Huang, Taipei (TW)

(73) Assignee: INVENTEC CORPORATION, Taipei (TW)

(21) Appl. No.: 12/761,166

(22) Filed: Apr. 15, 2010

(30) Foreign Application Priority Data
Nov. 6, 2009 (TW) 098137713

(51) Int. Cl. G06F 1/24; G06F 9/00

(52) U.S. Cl. 713/1

(57) ABSTRACT

A basic input/output system (BIOS) capable of supporting multi-platforms and a constructing method thereof are provided. In the method, a plurality of segment modules is provided, and each of the segment modules includes more than one BIOS module. A module header is established for each of the BIOS modules and records an application platform identifier (ID) of an applicable platform of the corresponding BIOS module and module type data of the corresponding BIOS module. The segment modules are then integrated according to a design structure of the BIOS. The segment modules are classified into a main system module, a plurality of slave segment modules, and a reset entry segment module. When the reset entry segment module obtains a platform ID of an electronic equipment currently configured with the BIOS, the main system module pre-stores an execution sequence according to the platform ID, and sequentially runs the BIOS modules matching with the platform ID.

### BACKGROUND OF THE INVENTION

1. Field of Invention

The present invention relates to a constructing method of a basic input/output system (BIOS), and more particularly to a BIOS capable of supporting hardware devices of different platforms and a constructing method thereof.

2. Related Art

In the prior art, the technology of employing a single BIOS to support multi-platforms has already been proposed. The BIOS includes a main BIOS module and more than one platform module. The main BIOS module is mainly used for recording power-on self-test (POST) programs to be executed and hardware settings when the BIOS is configured in an electronic equipment, and recording the platform modules to be executed when the BIOS is applied to electronic equipments on different platforms.

In order to guarantee that the BIOS can be applied in the electronic equipments on different platforms, designers need to put forward a highly compatible platform module capable of being used for different platforms. Thus, the designers usually integrally design a platform-dependent module or adopt no individual design manner, so as to try to meet the design requirements.

Unfortunately, the above design method further increases the design difficulties of the BIOS. In detail, due to the integral design or non-individual design of the platform module, the program complexity of the platform module is dramatically increased, so that the designers cannot easily read or debug the program code.

Moreover, as the program code is difficult to read, errors in the program code cannot be easily found. Besides, the program complexity is too high and causes difficulties in adjusting or modifying the program. In addition, as the program code is difficult to debug or read, it is difficult to clarify error points in the program of the platform module, and it is also difficult to ensure that the program code added for correction only corrects errors in the program without affecting the normal operation of electronic equipments on other platforms.

### SUMMARY OF THE INVENTION

In order to solve the above problems, the present invention is directed to a BIOS structure capable of being applied to multi-platforms and a constructing method thereof, so as to simplify the research and development of the BIOS and facilitate the reading, adjustment, and debugging operations.

According to the above, the present invention provides a constructing method of a BIOS capable of supporting multi-platforms, which includes the following steps. A plurality of segment modules is provided, and each of the segment modules includes at least one BIOS module. A module header is established for each of the BIOS modules, and the module header includes module type data and at least one application platform identifier (ID) of the BIOS module corresponding to the module header. The segment modules are then integrated according to a design structure of the BIOS.

The present invention also provides a BIOS capable of supporting multi-platforms, which is configured in an electronic equipment. The BIOS includes a reset entry segment module, a plurality of slave segment modules, and a main system module. Each of the slave segment modules includes at least one BIOS module and a corresponding module header. The module header includes module type data and at least one application platform ID of the BIOS module corresponding to the module header. The reset entry segment module reads a platform ID pre-stored in the electronic equipment, and starts a main BIOS module in the main system module according to the platform ID. The main BIOS module records an execution sequence of all the slave segment modules, and matches the platform ID with the application platform ID, so as to run at least one of the BIOS modules matching with the platform ID according to the execution sequence.

The present invention achieves the following beneficial effects. A module header is established for each of the BIOS modules, and each module header stores applicable platforms of the BIOS module corresponding to the module header and properties of the corresponding BIOS module. The program code of each BIOS module is actually divided and distinguished, and a corresponding relation between the BIOS module and each platform is clearly marked. Thus, the complexity of the program code is reduced, the difficulty for the designers to read and debug the program code is lowered, and errors in the program code can be easily found. Moreover, the adjustment and modification of the program become much easier, and the error points in the program of the platform module can be easily clarified, so that the designers can adjust the program by correcting the errors in the program without affecting the operation of the overall BIOS in electronic equipments on other platforms.

### BRIEF DESCRIPTION OF THE DRAWINGS

FIG. 1 is a flow chart of a constructing process of a BIOS capable of supporting multi-platforms according to an embodiment of the present invention;

FIG. 2 is a schematic view of segment modules according to an embodiment of the present invention;

FIG. 3 is a schematic view of a configuration of BIOS modules and module headers according to an embodiment of the present invention;

FIG. 4 is a schematic view of a specification of a module header according to an embodiment of the present invention;

FIG. 5 is a schematic view of an applicable platform of the BIOS according to an embodiment of the present invention;

FIG. 6 is a schematic view of a configuration of BIOS modules according to an embodiment of the present invention; and

FIG. 7 is a schematic view of an applicable platform of the BIOS according to another embodiment of the present invention.

### DETAILED DESCRIPTION OF THE INVENTION

Preferred embodiments of the present invention are illustrated in detail below with reference to the accompanying drawings.

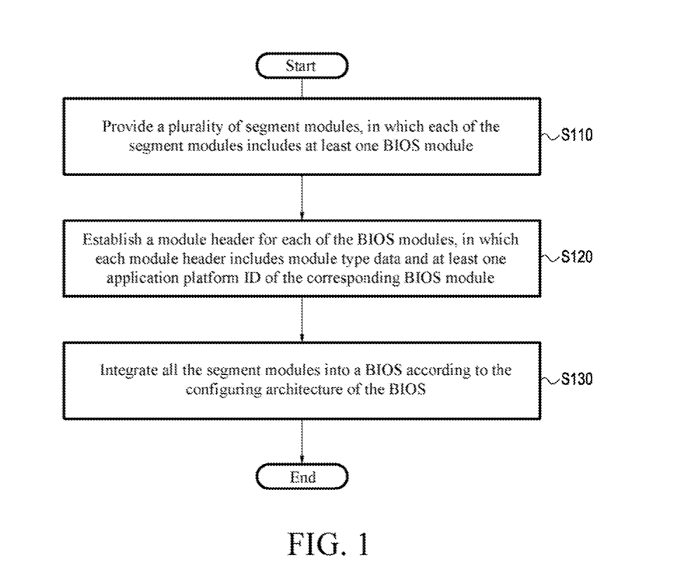

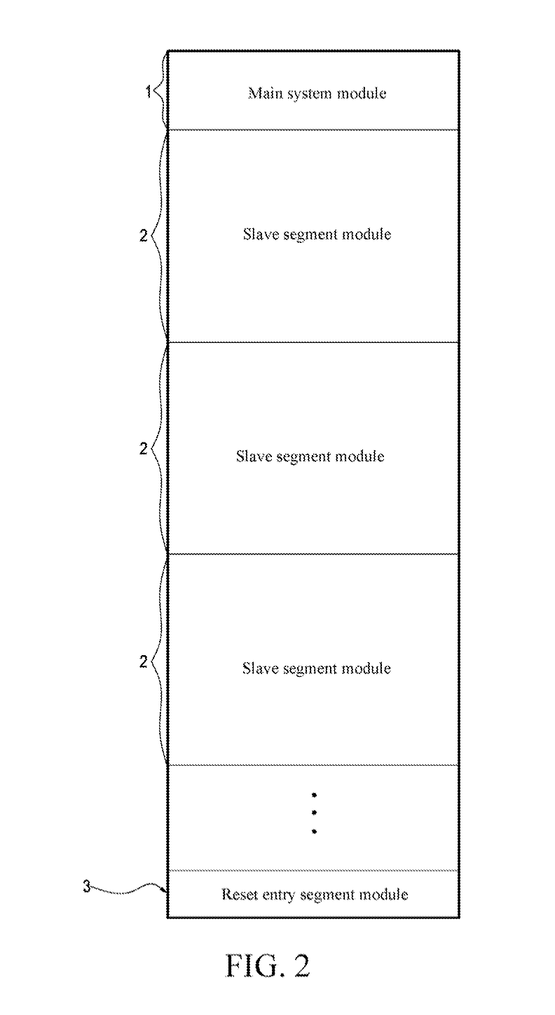

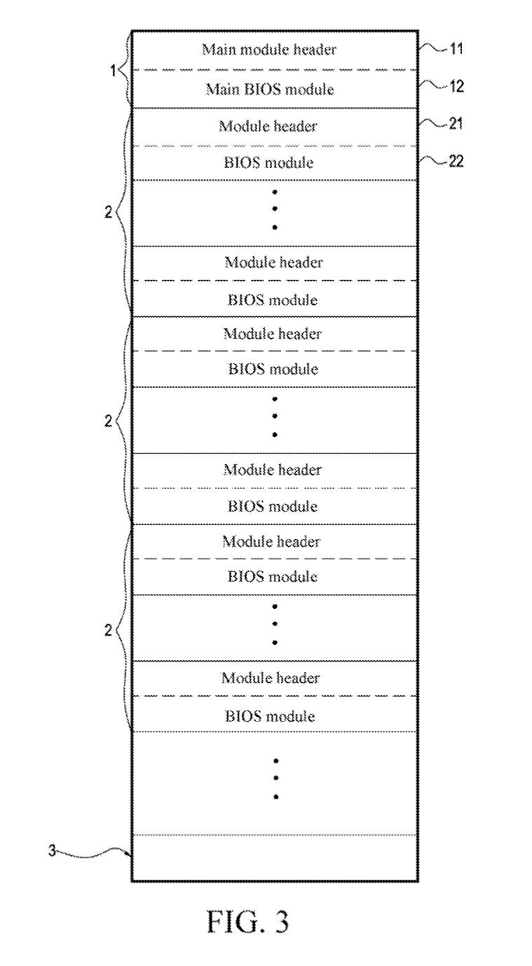

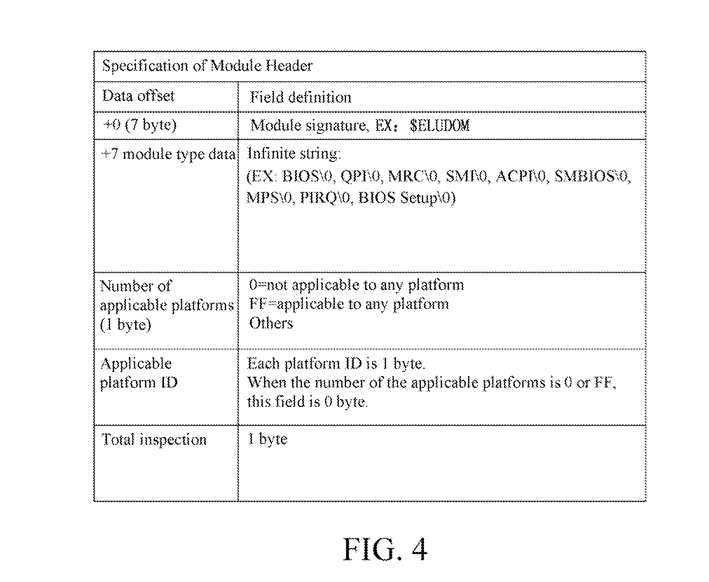

FIG. 1 is a flow chart of a constructing process of a BIOS capable of supporting multi-platforms according to an embodiment of the present invention, FIG. 2 is a schematic view of segment modules according to an embodiment of the present invention, FIG. 3 is a schematic view of a configuration of BIOS modules and module headers according to an embodiment of the present invention, and FIG. 4 is a schematic view of a specification of a module header according to an embodiment of the present invention. Referring to FIGS. 1 to 4, a constructing method of a BIOS capable of supporting multi-platforms in this embodiment includes the following steps.

A plurality of segment modules is provided, and each of the segment modules includes at least one BIOS module (Step S110). Referring to FIG. 2, the segment modules are classified into three types: a main system module 1, a plurality of slave segment modules 2, and a reset entry segment module 3. Referring to FIG. 3, in this embodiment, the main system module 1 includes more than one main BIOS module 12, and each of the slave segment modules 2 includes more than one BIOS module 22. It should be noted that, the BIOS modules 22 belonging to the same slave segment module 2 may have the same or similar functions, but are applicable to different hardware platforms, so that the program codes of the BIOS modules 22 are somewhat different.

In this embodiment, the slave segment modules 2 include a quick path interconnect (QPI) reference code module 4, a memory reference code (MRC) module 5, a system management interrupt (SMI) reference code module, an advanced configuration and power interface (ACPI) reference code module, and a system management basic input output system (SMBIOS) module. The slave segment modules 2 may even include a multi-processor system (MPS) module, a programmable interrupt request (PIRQ) module, and a BIOS setup module.

A module header 21 is established for each of the BIOS modules 22 (Step S120). A module header 21 is applied to each of the BIOS modules 22, and each module header 21 includes module type data and at least one (which may also be 0 or another integer) application platform ID of the corresponding BIOS module 22. In this embodiment, a specification of the module header 21 is shown in FIG. 4, but the present invention is not limited thereto. In FIG. 4, the content of the module header 21 includes a module signature, a module type, a number of applicable platforms, application platform IDs, and total inspection bits.

Finally, according to configuring architecture of the BIOS in a memory space, all the segment modules are stored in the memory space and integrated into a BIOS (Step S130).

Referring to FIG. 3, in this embodiment, the configuring architecture of the BIOS in the memory space includes the main system module 1, the plurality of slave segment modules 2, and the reset entry segment module 3 in sequence.

The BIOS modules 22 include more than one independent module. The independent module has low data dependency in execution, which may not exchange data with the other BIOS modules. Furthermore, the BIOS modules 22 include more than two dependent modules. The dependent modules have high data dependency and perform data transmission during the execution of the program code. When one BIOS module intends to use services on the other BIOS modules, the other BIOS modules need to first log in to more than one data-dependency service program on the main BIOS module 12, and then request the main BIOS module 12 for the services.

The operation of the BIOS in this embodiment is illustrated as follows. The BIOS in this embodiment is configured in an electronic equipment. The reset entry segment module 3 first obtains a platform ID pre-stored in a hardware module of the electronic equipment via a general purpose interface of the electronic equipment, and then starts the main BIOS module 12 in the main system module 1 according to the platform ID. The main BIOS module 12 records an execution sequence of all the slave segment modules 2 and a POST operating instruction. The main BIOS module 12 runs the BIOS modules 22 matching with the platform ID according to the execution sequence, and executes the related operating instruction to complete the POST operation and initialize related hardware of the electronic equipment.

However, when the main system module 1 includes more than one main BIOS module 12, each main BIOS module 12 is configured with a main module header 11, and the specification of the main module header 11 is the same as that of the module headers 21 corresponding to the BIOS modules 22. The main module header 11 includes module type data and at least one application platform ID of the corresponding main BIOS module 12. In this embodiment, the specification of the module header 21 is shown in FIG. 4, but the present invention is not limited thereto. After obtaining the platform ID, the reset entry segment module 3 compares the platform ID with the application platform ID included in each main module header 11, and transfers the platform ID and the control right of a central processing unit (CPU) 61 to the main BIOS module 12 matching with the platform ID for subsequent operation.

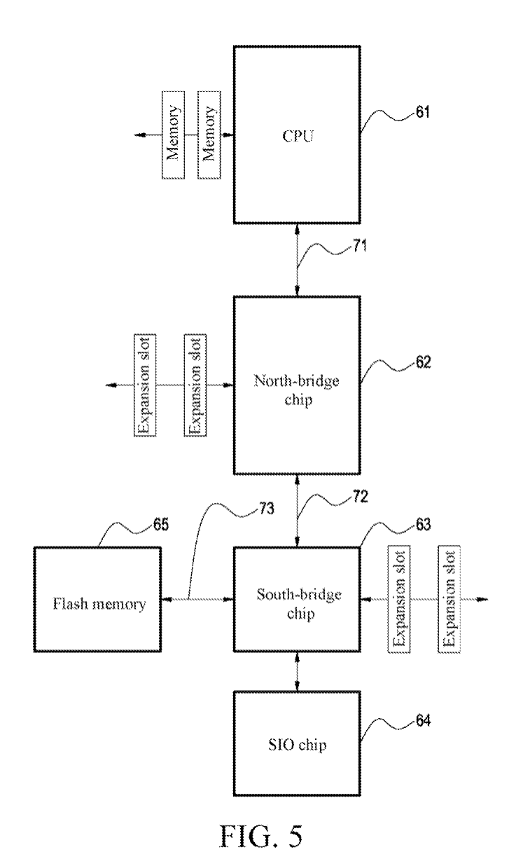

Referring to FIGS. 3 and 5, FIG. 5 is a schematic view of an applicable platform of the BIOS according to an embodiment of the present invention. The BIOS in this embodiment is configured in an electronic equipment and has a hardware platform as shown in FIG. 5. The hardware platform includes a CPU 61, a north-bridge chip 62, a south-bridge chip 63, a flash memory 65, and a super input-output (SIO) chip 64. The BIOS is configured in the flash memory 65, but the present invention is not limited thereto.

The BIOS includes a reset entry segment module 3, a plurality of slave segment modules 2, and a main system module 1. The main system module 1 includes more than one main BIOS module 12, and the main BIOS module 12 records an execution sequence of all the slave segment modules 2. In this embodiment, one main BIOS module 12 is provided for ease of illustration, which indicates that the main BIOS module 12 is applicable to all the hardware platforms.

Each of the slave segment modules 2 includes more than one BIOS module and a corresponding module header 21. The module header 21 includes module type data and at least one (which may also be 0 or another integer) application platform ID of the corresponding BIOS module 22. A specification of the module header 21 is shown in FIG. 4, but the present invention is not limited thereto. The specification of the module header 21 is illustrated above, and the details are not described herein again.

When the electronic equipment is started or reset, the CPU 61 first reads the BIOS in the flash memory 65, and the read segment is the reset entry segment module 3. When the reset entry segment module 3 is executed by the CPU 61, the reset entry segment module 3 obtains a platform ID pre-stored in a hardware module of the electronic equipment (including the CPU 61, the north-bridge chip 62, the south-bridge chip 63, various types of memories, and various types of electronic devices electrically coupled inside and outside the electronic equipment) via a general purpose interface of the electronic equipment (including a QPI 71, a serial peripheral interface (SPI) 73, a direct media interface (DMI) 72, or an enterprise south-bridge interface (ESI)), and transfers the platform ID and the control right of the CPU 61 to the main BIOS module 12.

Afterwards, the main BIOS module 12 loads the slave segment modules 2 one by one according to the execution sequence of the slave segment modules 2, selects the slave segment module 2 having the application platform ID matching with the previously obtained platform ID from all the loaded slave segment modules 2, and executes the program code of the slave segment module 2.

The BIOS modules 22 include more than one independent module. The independent module has low data dependency in execution, which may not exchange data with the other BIOS modules. Furthermore, the BIOS modules 22 include more than two dependent modules. The dependent modules have high data dependency and perform data transmission during the execution of the program code. When one BIOS module intends to use services on the other BIOS modules, the other BIOS modules need to first log in to more than one data-dependency service program on the main BIOS module 12, and then request the main BIOS module 12 for the services.

In this embodiment, the slave segment modules 2 include a QPI reference code module 4, an MRC module 5, an SMI reference code module, an ACPI reference code module, and an SMBIOS module. The slave segment modules 2 even include an MPS module, a PIRQ module, and a BIOS setup module.

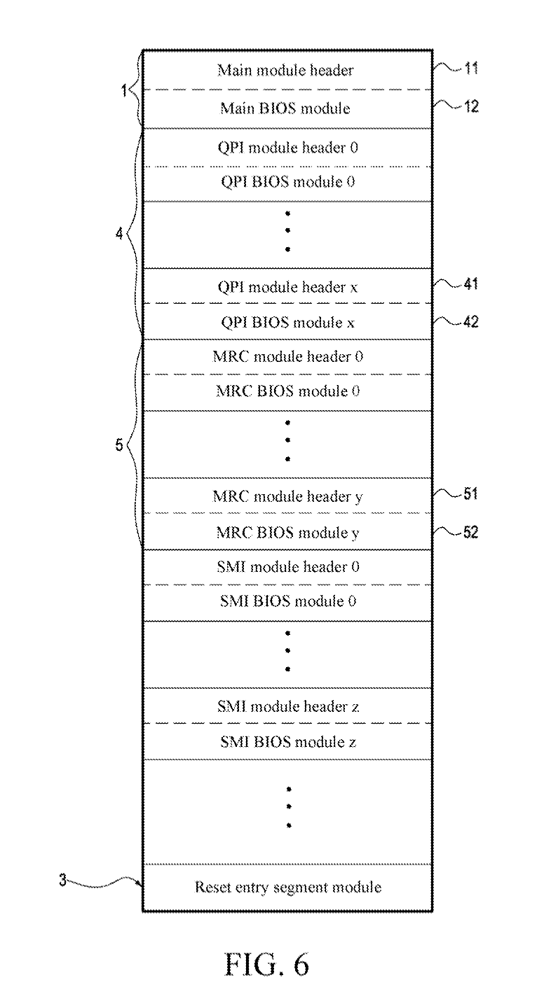

FIG. 6 is a schematic view of a configuration of BIOS modules according to an embodiment of the present invention. Referring to FIG. 6, in an example, the main BIOS module 12 loads the QPI reference code module 4, and the previously obtained platform ID is “01010101”. The main BIOS module 12 controls the CPU 61 to read each QPI module header of the QPI reference code module 4, so as to find out a BIOS module having module type data as “QPI” and an application platform ID as “01010101”, for example, an x^{th} QPI module header 41. The main BIOS module 12 transfers the control right of the CPU 61 to an x^{th} QPI BIOS module 42, so that the program code included in the x^{th} QPI BIOS module 42 is executed, thereby completing the QPI program loading, executing, and parameter setting operations. Afterwards, the x^{th} QPI BIOS module 42 returns the control right of the CPU 61 to the main BIOS module 12.

In another example, the main BIOS module 12 loads the MRC module 5, and the previously obtained platform ID is “01010101”. The main BIOS module 12 controls the CPU 61 to find out a BIOS module having module type data as “MRC” and an application platform ID as “01010101” from the MRC module 5, for example, a y^{th} MRC module header 51. The main BIOS module 12 transfers the control right of the CPU 61 to a y^{th} MRC BIOS module 52, so that the program code included in the y^{th} MRC BIOS module 52 is executed, thereby completing the MRC program loading, executing, and parameter setting operations. Afterwards, the y^{th} MRC BIOS module 52 returns the control right of the CPU 61 to the main BIOS module 12.

Likewise, the program loading, executing, and parameter setting operations for the SMI, ACPI, SMBIOS, MPS, PIRQ, and BIOS Setup can be implemented in the same manner.

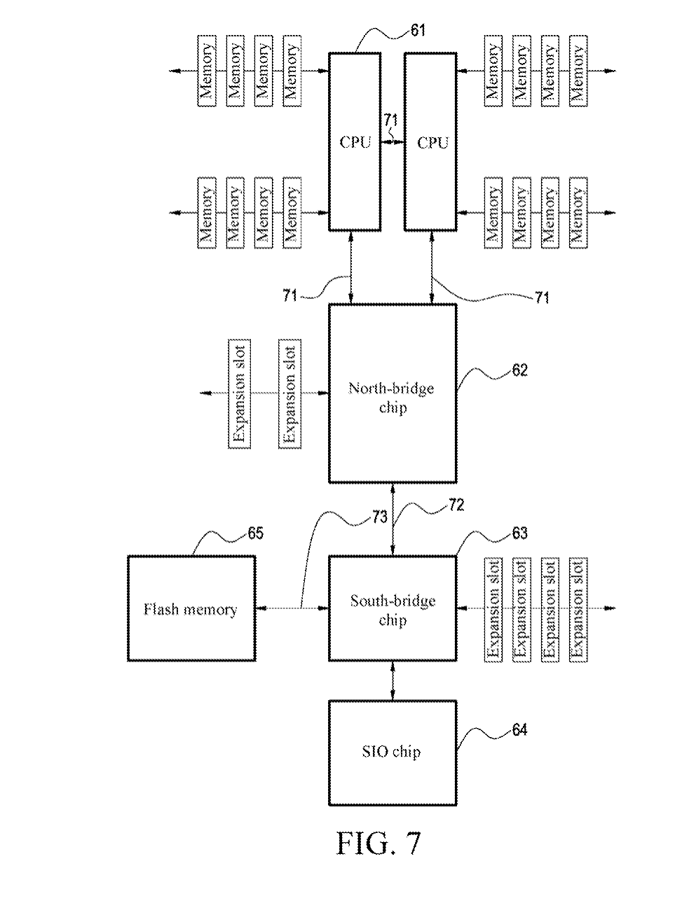

FIG. 7 is a schematic view of an applicable platform of the BIOS according to another embodiment of the present invention. The difference between the platform of this embodiment and that shown in FIG. 5 lies in that, the applicable platform of the BIOS in FIG. 5 has single-CPU architecture, and the applicable platform of the BIOS in FIG. 7 has double-CPU architecture. The above two platforms are both applicable to the BIOS constructing technology and executing modules of the present invention. The implementation of the constructing technology has already been illustrated above and may not be described herein again.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A constructing method of a basic input/output system (BIOS) capable of supporting multi-platforms, comprising:
providing a plurality of segment modules, wherein each of the segment modules comprises at least one BIOS module;
establishing a module header for each BIOS module, wherein each module header comprises module type data and at least one application platform identifier (ID) of the corresponding BIOS module; and
integrating the segment modules into a BIOS.

2. The constructing method of a BIOS capable of supporting multi-platforms according to claim 1, wherein the BIOS modules comprise at least one independent module for logging in to at least one data-dependency service program on a main BIOS module, so as to request the main BIOS module to assist the at least one independent module to run the at least one service program.

3. The constructing method of a BIOS capable of supporting multi-platforms according to claim 1, wherein the BIOS modules comprise at least two dependent modules, and the dependent modules perform data transmission during execution.

4. The constructing method of a BIOS capable of supporting multi-platforms according to claim 1, wherein the segment modules comprise a main system module, a plurality of slave segment modules, and a reset entry segment module, the reset entry segment module reads a platform ID of an electronic equipment configured with the BIOS and starts a main BIOS module in the main system module according to the platform ID, and the main BIOS module records an execution sequence of the slave segment modules and runs at least one of the BIOS modules matching with the platform ID according to the execution sequence.

5. The constructing method of a BIOS capable of supporting multi-platforms according to claim 4, wherein the slave segment modules comprise a quick path interconnect (QPI) reference code module, a memory reference code (MRC) module, a system management interrupt (SMI) reference code module, an advanced configuration and power interface (ACPI) reference code module, and a system management basic input output system (SMBIOS) module.

6. The constructing method of a BIOS capable of supporting multi-platforms according to claim 5, wherein the slave segment modules further comprise a multi-processor system (MPS) module, a programmable interrupt request (PIRQ) module, and a BIOS setup module.

7. The constructing method of a BIOS capable of supporting multi-platforms according to claim 1, wherein a value of the at least one application platform ID comprises 0 or an integer.

8. A basic input/output system (BIOS) capable of supporting multi-platforms, configured in an electronic equipment, the BIOS comprising:
a reset entry segment module, for obtaining a platform identifier (ID) pre-stored in the electronic equipment via a general purpose interface of the electronic equipment;
a plurality of slave segment modules, each comprising at least one BIOS module and a corresponding module header, wherein the module header comprises module type data and at least one application platform ID of the corresponding BIOS module; and
a main system module, comprising at least one main BIOS module, wherein the main BIOS module records an execution sequence of the slave segment modules, and matches the platform ID with the application platform IDs, so as to run at least one of the BIOS modules matching with the platform ID according to the execution sequence.

9. The BIOS capable of supporting multi-platforms according to claim 8, wherein the BIOS modules comprise at least one independent module for logging in to at least one data-dependency service program on the main BIOS module, so as to request the main BIOS module to assist the at least one independent module to run the at least one service program.

10. The BIOS capable of supporting multi-platforms according to claim 8, wherein the BIOS modules comprise at least two dependent modules, and the dependent modules perform data transmission during execution.

11. The BIOS capable of supporting multi-platforms according to claim 8, wherein the slave segment modules comprise a quick path interconnect (QPI) reference code module, a memory reference code (MRC) module, a system management interrupt (SMI) reference code module, an advanced configuration and power interface (ACPI) reference code module, and a system management basic input output system (SMBIOS) module.

12. The BIOS capable of supporting multi-platforms according to claim 11, wherein the slave segment modules further comprise a multi-processor system (MPS) module, a programmable interrupt request (PIRQ) module, and a BIOS setup module.

13. The BIOS capable of supporting multi-platforms according to claim 8, wherein a value of the at least one application platform ID comprises 0 or an integer.
